(19) United States
(12) Patent Application Publication
(10) Pub. No.: US 2007/0224024 A1
(43) Pub. Date: Sep. 27, 2007

(54) Extended platform structure of container cars

(76) Inventor: Ren-Yang Yang, Minsyong Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/374,216

(22) Filed: Mar. 14, 2006

(51) Int. Cl. B60P 1/00

(52) U.S. Cl. 414/522

(57) ABSTRACT

It is a main object of the invention to provide an extended platform structure which is consisted of three platforms inside the containers, and all of the platforms can be extended out of the containers to be a stage or serve as an automatic mechanical platform holder. A container for this invention is connected to a tractor-trailer and comprises the first, second and third platforms therein. The first slide rail is set between the first and the second platforms, and the second slide rail between the second and the third platforms. The first propeller is connected to the first and the second platforms, and the second propeller is connected to the second and the third platforms which enable these three platforms to make relative movements. A pair of the first sustaining supports is fitted at both sides of the second platform and a pair of the second sustaining supports fitted at both sides of the third platform can prop against the ground for sustaining purpose. A holder is set up on the top of the third platform for loading. As a consequence, these three platforms can be extended out of containers in turn, each sustaining support against ground for loading and avoid tilting and turning over.

### BACKGROUND OF THE INVENTION

1. Field of the Invention

The present invention relates to extended platform structure of container cars, more particularly one, which is structured in a way that three extended platforms built in it, the second and the third platforms are kept up stable by sustaining support set up. The third platform set up a piece of holder to provide load that container cars are not only carrying containers but containers can serve as display stage.

2. Brief Description of the Prior Art

According to existing containers cars consisted of tractor-trailer and container, wheels are connected to the bottom of containers connected to tractor-trailer and various size of containers are useful for connecting tractor-trailer to achieve the purpose of carrying containers from unload cargo port to inland or from storehouse to exported port or carrying large-size cargos from one to another place, thus, container cars can be used in a long-range journey, for purpose of carrying large cargos and served as mechanical working platforms.

Size of container cars are 20 feet and 40 feet in general, 20 feet empty container is 2.3 tons weight and 40 feet empty container is 3.69 tons. Users choose the size of containers in need to avoid exposing to the sun and rain and fork lift truck transports and piles up cargos while transportation.

However, in addition to transportation or storing, containers of container cars have other functions like mobile stages or mechanical working platform and container cars can be a stage rent, an automatic mechanical platform to extend service range and promote utility rate.

### SUMMARY OF THE INVENTION

It is a main object of the invention to provide an extended platform structure which is consisted of three platforms inside the containers and all of the platforms are extended out of the containers to be a stage or an automatic mechanical platform holder.

For the purpose, platforms of the invention are set up inside containers which are connected to tractor-trailer, these extended platforms comprise the first, the second and the third platforms, a first slide rail is between the first and the second platforms, and a second slide rail is between the second and the third platforms. Still, a first propeller is connected between the first and the second platforms, and a second propeller is connected between the second and the third platforms which enable these three platforms have relative displacements. A pair of first sustaining supports fitted on the both sides of the second platform, and a pair of second sustaining supports fitted on the both sides of the third platform can adjustably lean against the ground, and a holder is set up on the top of the third platform for loading. Accordingly, these three platforms can be extended out of containers in turn, each sustaining support against ground for loading and avoid tilting and turning over.

### BRIEF DESCRIPTION OF THE DRAWINGS

The present invention will be better understood by referring to the accompanying drawings, wherein:

FIG. 1 is a three-dimensional perspective view which shows the spread state of platforms.

FIG. 2 is a vertical section of FIG. 1.

FIG. 3 is a front elevation of FIG. 1 which describes spread and collapsible states of platforms.

FIG. 4 is a three-dimensional perspective view which shows the collapsible state of platforms.

FIG. 5 is a front elevation of FIG. 4.

### DETAILED DESCRIPTION OF THE PREFERRED EMBODIMENTS

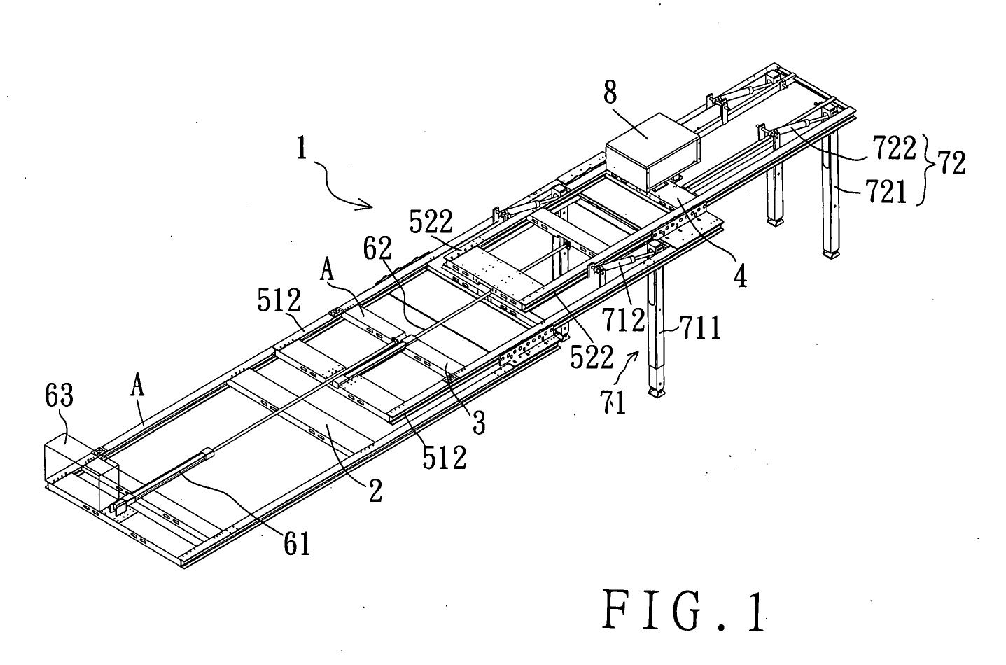

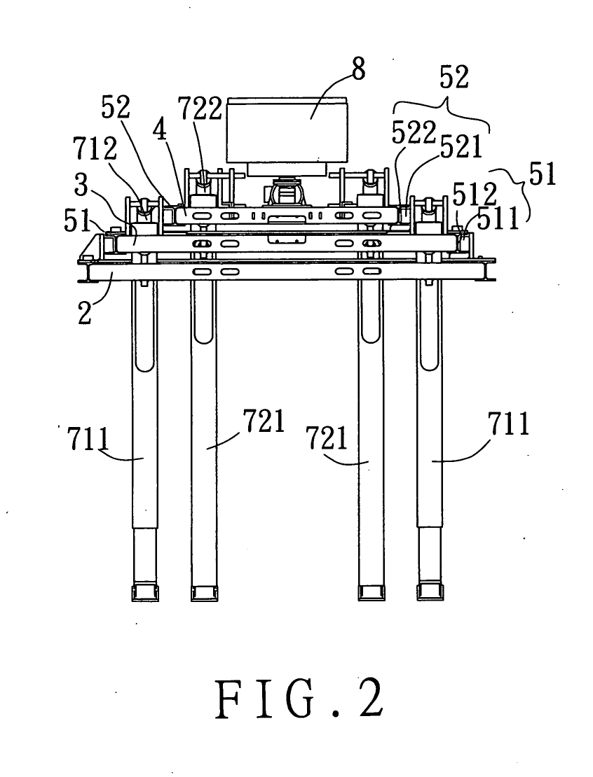

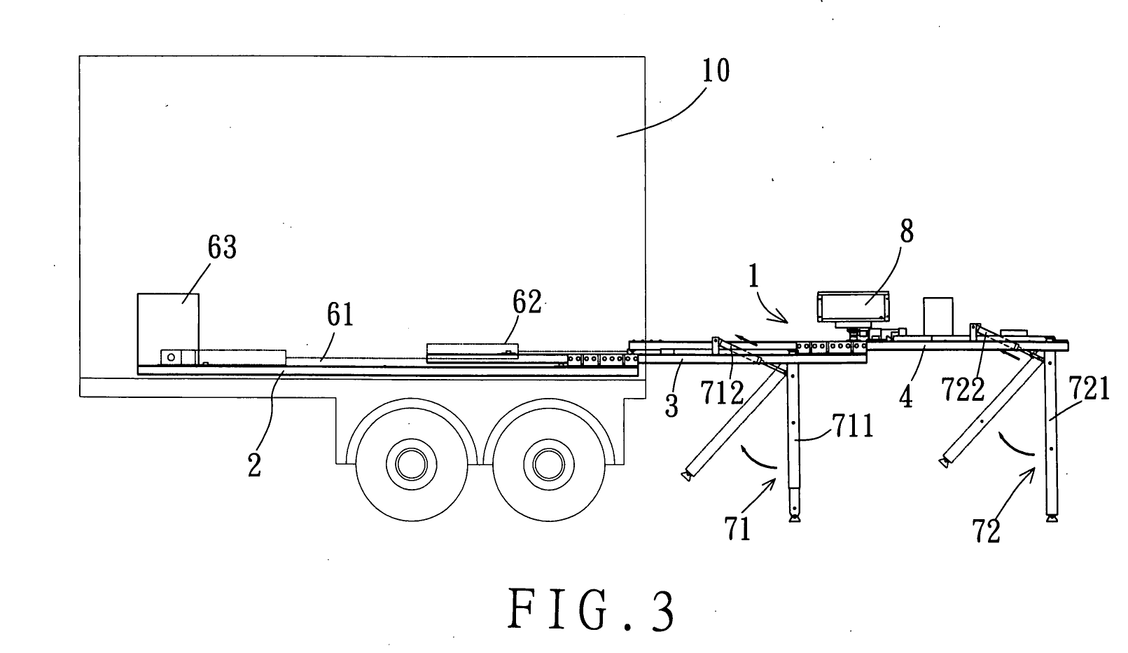

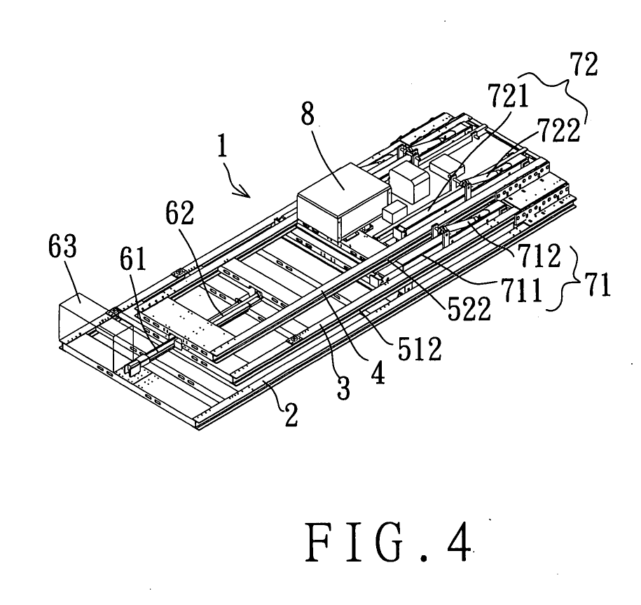

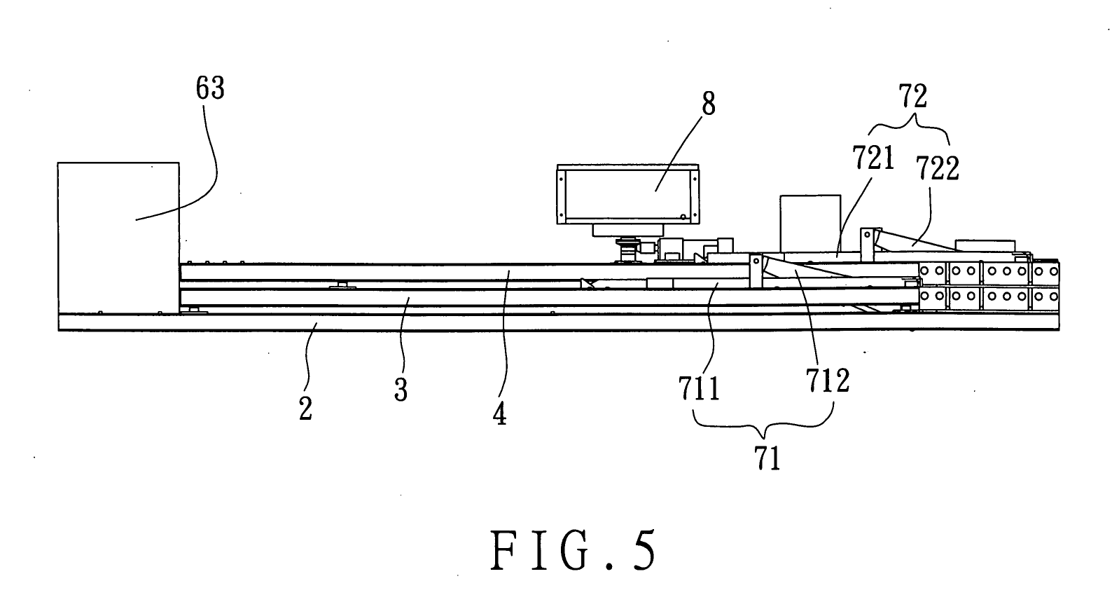

As referring to FIGS. 1 to 5, a preferred embodiment of extended platform set up inside container cars of the invention, and an extended platform 1 is set up inside containers 10 connected to tractor-trailer (not shown). The extended platform 1 includes the first, second and the third platform 2, 3, 4, wherein the square measure of the first platform 2 is larger than that of the second platform 3, and the superficial measure of the second platform 3 is larger than that of the third platform 4 to make the whole structure stable. Vertical or lateral slabs or shafts defined each of the first, second and third platforms 2, 3, 4 can provide best efficacy of lowering the weight and volume of the first, second and third platforms 2, 3, 4.

A first slide rail 51 is set up between the first platform 2 and the second platform 3 as well as a second slide rail 52 set up between the second platform 3 and the third platform 4. The first slide rail 51 includes wheels 511 set on both sides of the first platform 2 and rails 512 set on both sides of the second platform 3. The rails 512 made of H steel can allow wheels 511 to fit in rails 512 for rolling, such that the first 2 platform and the second platform 3 can move relatively. The second slide rail 52 includes wheels 521 set on both sides of the second platform 3 and rails 522 on both sides of the third platform 4; similarly, the rail 522 made of H steel can allow the wheels 521 to fit in the rails 522 for rolling, such that the second 3 and third platforms 4 can move relatively. For the above, the first and the structure of the first and second slide rails 51, 52 can not only make those platforms slide without obstacles but further avoid reversing between the platforms.

The first propeller 61 connected to the first 2 and the second platform 3 can make the two platforms displaced relatively, especially one end of the first propeller 61 fixed on the first platform 2, another end thereof fixed on the seconded platform 3. The first propeller 61 is telescopic to make the first and the second platforms 2, 3 displaced relatively. The second propeller 62 connected to the second and the third platforms 3, 4 can make the same move relatively, especially one end of the second propeller 62 fixed on the second platform 3 and another end thereof fixed on the third platform 4. Due to the telescopic property of the second propeller 62, the second and third platform 3, 4 can move relatively. A driving mechanism 63 set at one end of the first platform 2 has a generator and an oil pump controller built in for power supply.

A pair of the first sustaining supports 71 is set on both sides of the second platform 3 and a pair of the second sustaining supports 72 set on both sides of the third platform 4. The first sustaining support 71 includes sustaining shafts 711 and telescopic loading components 712, in which one ends of sustaining shaft 711 and telescopic loading components 712 can be connected to the second platform 3 and another end of the telescopic loading components 712 connected to a proper place of the sustaining shaft 711, telescopic loading component 712 pushes the sustaining shaft 711 to make sustaining shaft 711 being vertical to the second platform 3 for sustaining purpose. At the same way, the second sustaining support 72 includes sustaining shafts 721 and telescopic loading components 722, in which one ends of the sustaining shaft 721 and telescopic loading component 722 are connected to the third platform 4, and another end of the telescopic loading component 722 connected to sustaining shaft 721. Still, the telescopic loading component 722 can push sustaining shaft 721 to make the sustaining shaft 721 being vertical to the third platform 4 for sustaining purpose.

The sustaining shafts 711, 721 of each sustaining support 71, 72 are telescopic, thus it can be tunable to provide stabilization against ground to make sustaining supports stabilizing all of the platforms and avoid reversing. On the top of the third platform 4 set up a holder 8 for heavy loading, the holder 8 is set up immovably and designed for reversing, tiling, raising and falling.

In addition to the above-mentioned embodiments, the first slide rail 51 of this invention can be changed into a linear slide rail, which can be set up between both sides of the first platform 2 and both sides of the second platform 3, such that the first and the second platforms 2, 3 can move relatively. In the same way, the second slide rails 52 can be also changed into linear slide rails set up between the both sides of the second platform 3 and the both sides of the third platform 4 to make the second and the third platform 3, 4 moved relatively as a main purpose.

Prior description examples or figures are not limitation of structure or scale for the invention, people who own common technology can change or modify the invention in all of the technology fields but they are all belonged to the patent claiming.

We can understand from the prior description, advantages of the invention as listed below.
1. Containers are dragged to somewhere by tractor-trailer and each platform pushed out of the original place in turn. Still, sustaining supports are pushed to be vertical to ground by telescopic loading component directly; accordingly, it can enhance efficiency of containers due to it works fast and expand the usage extent for containers.
2. Sustaining supports are adjustably leaned against the ground to keep platforms stable, slide rails are set to avoid the relative reversing of every two platforms and container cars can be avoided tiling and turning over; thus, stabilization of platforms and container cars are improved greatly.

What is claimed is:

1. An extended platform structure of container cars, comprising a first, second and third platforms,
said first slide rail set up between the first and the second platforms;
said second slide rail set up between the second and the third platforms;
said first propeller connected between the first and the second platforms to make the two platforms move relatively;
said second propeller connected between the second and the third platforms to make the two platforms move relatively;
a pair of the first sustaining supports set on both sides of the second platform to prop against the ground;
a pair of the second sustaining supports set on both sides of the third platform to prop against the ground;
a holder set on the top of the third platform for heavy loading.

2. The extended platform structure of container cars as claimed in claim 1, wherein the first slide rail includes wheels set on both sides of the first platform and rails on both sides of the second platform to make the wheels fitted in the rails for rolling.

3. The extended platform structure of container cars as claimed in claim 1, wherein the first slide rail is a linear rail installed between both sides of the first platform and both sides of the second platform to make the first and second platforms move relatively.

4. The extended platform structure of container cars as claimed in claim 1, wherein the second slide rail includes wheels set on both sides of the second platform and rails on both sides of the third platform to make wheels fitted in rails for rolling.

5. The extended platform structure of container cars as claimed in claim 1, wherein the second slide rail is a linear rail set up between both sides of the second platform and both sides of the third platform to make the second and third platforms move relatively.

6. The extended platform structure of container cars as claimed in claim 1, wherein the first sustaining support includes sustaining shafts and telescopic loading components, one ends of the sustaining shaft and telescopic loading component connected to the second platform, another end of the telescopic loading component connected to the sustaining shaft, and the telescopic loading component pushes sustaining shaft to make the sustain shaft vertical to the second platform for sustaining purpose.

7. The extended platform structure of container cars as claimed in claim 6, wherein each sustaining shaft is telescopic.

8. The extended platform structure of container cars as claimed in claim 1, wherein the second sustaining support includes sustaining shafts and telescopic loading components, one ends of the sustaining shaft and telescopic loading component connected to the third platform, another end of the telescopic loading component connected to the sustaining shaft, and the telescopic loading component pushes the sustaining shaft to make the sustaining shaft vertical to the third platform for sustaining purpose.

9. The extended platform structure of container cars as claimed in claim 8, wherein each sustaining shaft is telescopic.

10. The extended platform structure of container cars as claimed in claim 1, wherein the holder can be set on the third platform in a reversed, tilted and hoisted manners.
